(19) United States
(12) Patent Application Publication
(10) Pub. No.: US 2025/0367913 A1
(43) Pub. Date: Dec. 4, 2025

(54) PHA-RICH COMPOSTABLE FILM WITH IMPROVED OPTICAL PROPERTIES

(71) Applicant: TORAY PLASTICS (AMERICA), INC., North Kingstown, RI (US)

(72) Inventors: Shichen DOU, North Kingstown, RI (US); Joshua R. CLOUTIER, North Kingstown, RI (US)

(21) Appl. No.: 18/678,422

(22) Filed: May 30, 2024

(51) Int. Cl. B32B 27/08; B32B 27/18; B32B 27/36

(52) U.S. Cl. CPC B32B 27/08; B32B 27/18; B32B 27/36; B32B 2250/24; B32B 2250/40; B32B 2264/1021; B32B 2270/00; B32B 2307/308; B32B 2307/31; B32B 2307/414; B32B 2307/518; B32B 2307/54; B32B 2307/702; B32B 2307/704; B32B 2307/7163

(57) ABSTRACT

A biaxially oriented PHA-rich composite film comprises a PHA-rich core layer and a first outer skin layer and a second outer skin layer. The core layer comprises a PHA resin at an amount of more than 50 wt % of a total weight of the polymeric resin in the core layer and a modifier X, the modifier X includes PLA resins and PLA copolymers; the first outer skin layer comprises a PLA resin at an amount less than 50 wt % of the total weight of the outer layer and a polymer blend Y comprising PHA, PBSA and PCL resins. The PHA-rich composite film shows improved optical properties, high elongation force, high tensile strengths and Young's modulus.

### FIELD OF THE INVENTION

This invention relates to a biaxially oriented multi-layer compostable PHA-rich composite film with improved optical properties, high elongation force, high tensile strength, and Young's modulus while the biodegradability and compostability are controlled at the level required for home composting.

### BACKGROUND OF INVENTION

Recently, the increasing interest in biodegradable and compostable film for the application of packaging and labels has been strongly developing. Compostable materials based on biologically derived polymers are being attracted due to concerns with plastic pollution, renewable resources, raw materials, and greenhouse gas generation. Bio-based plastics are believed to help reduce reliance on petroleum, reduce production of greenhouse gases, and eliminate plastic pollution. Products made from bio-based plastics could be biodegradable or compostable through formulating selected biomaterials.

Bio-based plastics such as polylactic acid (PLA) and polyhydroxyalkanoates (PHA) derived from a renewable resource are the most popular and commercially available for film applications. Polybutylene succinate (PBS) or polybutylene succinate-co-adipate (PBSA) is a partially bio-based biodegradable polymer. Other biodegradable polymers such as poly(ε-caprolactone) (PCL) and polybutylene adipate terephthalate (PBAT) that are petroleum-based biodegradable polymers are largely available at the time of this writing to address the concerns of plastics pollution and “End of Life” of disposable or single use application such as the application of snack food packaging and label film.

Biaxially oriented polylactic acid (BOPLA) films are transparent with a high clarity and high gloss as well as high Young's modulus (in another words high stiffness), which are very desirable for printing graphics with high visual appearance and for forming rigid container such as stand pouches of a single materials packaging. Biaxially oriented PLA film could also be a good candidate for label film application due to its high tensile strength and Young's modulus. However, BOPLA film is only industrial compostable under a controlled temperature environment of 58±2° C. (ASTM D 5338-15), this approach has a drawback due to the limited public availability of industrial composting facilities.

Polyhydroxyalkanoates (PHAs) are a group of renewable biodegradable polyesters that are synthesized by mainly microorganisms from renewable sources including sugars obtained from lignocellulosic biomasses, agricultural wastes, starches, and vegetable oils; PHAs are completely biodegradable and converted into CO₂ and H₂O in soil and oceans. PHAs are certified compostable bioplastics that could be used for making compostable products, such as containers, packaging films, and labels. However, PHA resins have a few disadvantages including their poor mechanical properties, poor thermal stability, long crystallization time, high production cost as well as incompatibility with conventional thermal processing techniques. Those drawbacks have limited their competition with traditional synthetic plastics or their application as ideal bioplastics. To overcome these drawbacks, PHAs must be modified with other bioplastics to meet the performance required for specific applications.

PLA resin is considered as one type of good candidate used to modify PHA resins for improving processability and stiffness, but the compostability of modified PHA/PLA alloy materials is maintained.

A PHA-rich composite is formulated to meet the specific requirements addressed herein.

PHA-rich composite is defined as that the content of PHAs is higher than 50 wt % (percent by weight) of the total weight of the composite, and a PHA-rich composite film has a core layer (base layer) comprising PHA resins not less than 50 wt % of the total weight of the polymeric resins in the core layer.

USPTO Pub. No.:US2023/0071141A1 describes a non-oriented multilayer PBSA-rich film produced by a coextruding process. The PBSA-rich composite film has extremely low tensile strength and low Young's modulus due to the softness of PBSA resin which has a low glass transition temperature of about −37° C. The application of the film either for packaging or label is limited due to its low mechanical strength.

USPTO Pub. No.:US2016/0253927A1 describes a method of making compostable film through a blow film process using pre-compounded well known compostable materials. The invented composite film showed low tear strength, low tensile strength, and low Young's modulus. Therefore, those films might be not suitable for the applications required for good tear strength and mechanical properties.

USPTO Pub. No.:US2022/0089914A1 describes a few compositions of PHA and PLA blends suitable for making composite label films with the compositions. However, the inventors did not provide the physical properties of PHA and PLA resins used in making composite label films as well as the process of how to make the composite label films. The physical properties of PHA and PLA resins used in their invention was unknown therefore a desirable composite label film could not be made with specific properties required for final label film products.

USPTO Pub. No.:US2024/0066848A1 describes a method of making biaxially oriented PHA-rich composite film with improved heat seal properties and mechanical properties, however, the invented PHA-rich composite films have high haze and low glosses, which are not suitable for the applications that are required for low haze and high glosses, in particular, the applications required for high transparency and shiny surface such as packaging film and label film.

Therefore, there exists a practical need for preparation of a biaxially oriented PHA-rich composite film for desirable optical properties, mechanical properties, home compostability by using cost-effective PLA resins. In the invention, inventors demonstrate how to use PLA resins with high melt flow rates as a modifier in the outer skin layers to improve the optical properties of the oriented PHA-rich composite films.

### SUMMARY OF INVENTION

Inventors demonstrate a preparation of a biaxially oriented PHA-rich composite film for packaging films and label films such as PSL with improved optical properties, mechanical properties, and home compostability by using PLA resins with a high melt flow rate (MFR) of 8 to 15 g/10 min. as a modifier in the outer skin layers to improve optical properties such as the haze and glosses of PHA-rich composite films.

In this invention, PLA resins as modifier in the core layer has melt flow rate of from 3 to 6 g/10 min. at the test condition of 190° C. and 2.16 Kg.

An embodiment relates to a multi-layer PHA-rich composite film comprising a PHA-rich core layer (B), a first outer skin layer (A), and a second outer skin layer (C); wherein the PHA-rich core layer comprises PHA resin and non-PHA modifier X, wherein the core layer has an amount of PHA resin more than 50 wt %, preferably, more than 60 wt %, and more preferably more than 70 wt % of the total weight of the polymeric resins in the core layer; wherein the non-PHA modifier X has a glass transition temperature of Tg≤60° C.; wherein an amount of the modifier X is less than 50 wt % of the total weight of the core layer; wherein the first outer skin layer comprises a PLA resin and a polymer blend Y; wherein the film is sequentially oriented in machine direction (MD) for 2 to 3.5 times and then in transverse direction (TD) for 3 to 5.5 times or the film is simultaneously oriented in both machine and transverse direction for a similar stretching ratio.

In an embodiment, wherein the PHA resin in the core layer includes semi-crystalline PHA resins such as PHB, PHBV, PHB-co-3HV, PHB-co-3HHx, PHB-co-3HO, and PHB-co-4HHx or mixtures thereof.

In an embodiment, the core layer comprises PHA resin at an amount of more than 50 wt %, preferably more than 60 wt %, more preferably more than 70 wt % of the total weight of the polymeric resins in the core layer.

In an embodiment, the PHA resin in the core layer has a crystallinity higher than 35 wt % determined by the method of differential scanning calorimetry (DSC).

In an embodiment, the PHA resin in the core layer has a melting temperature of 145 to 180° C.

In an embodiment, the total crystallinity of polymers in the core layer including the crystallinity of PHA and PLA resins and other bioplastics is higher than 35 wt % of the total weight of the polymeric resins in the core layer.

In an embodiment, the modifier X comprises PLA resins and PLA copolymers with a glass transition temperature of 40° C.≤Tg≤60° C.

In an embodiment, wherein the modifier X includes PLA resin at an amount of less than 50 wt % of the total weight of the core layer.

In an embodiment, the modifier X further optionally comprises an amount of less than 5 wt % petroleum-based polymeric modifier with a glass transition temperature of Tg≤10° C.

In an embodiment, the modifier X comprises PLA resins and PLA copolymers with crystallinity higher than 35% and a glass transition temperature in the range of 40 to 60° C.

In an embodiment, the core layer further optionally comprises a processing aid, a chain extender, a nucleating agent, a biodegradable promoter, a plasticizer, organic or inorganic particles and/or slip additives or mixtures thereof,

In an embodiment, the first outer skin layer (A) comprises a PLA resin at an amount less than 50 wt %, less than 40 wt % or less than 30 wt % and a polymer blend Y at an amount more than 50 wt %, 60 wt % or 70 wt % of the total weight of the first outer skin layer.

In an embodiment, the PLA resin in the outer skin layer is between 0 to 35 wt %, such as but not limited to 30 wt %, 25 wt %, 20 wt % or less.

In an embodiment, the PLA resin in the outer skin layer comprises semi-crystalline PLA resin, amorphous PLA resin and PLA copolymers or mixtures thereof with a melt flow index of 3 to 15 g/10 min., preferably, 6 to 15 g/10 min. at the test condition of 190° C. and 2.16 Kg.

In some embodiment, PLA resin has a melt flow index of about 8 to 15 g/10 min.

In an embodiment, the polymer blend Y in the first outer layer comprises PHA resins or polybutylene succinate-co-adipate (PBSA) or polycaprolactone (PCL) or other biodegradable polymers or mixtures thereof.

In an embodiment, the amount of the PHA resins in the outer skin layer is about 0 wt % to about 90 wt % of the total weight of the outer skin layer. For example: the amount of PHA resin in the outer skin layer could be 90 wt %, 80 wt %, 70 wt %, 60 wt %, etc.

In an embodiment, the amount of the PBSA in the outer skin layer is about 0 wt % to about 90 wt % of the total weight of the outer skin layer. For example: the amount of PBSA resin in the outer skin layer could be 90 wt %, 80 wt %, 70 wt %, 60 wt %, etc.

In an embodiment, the amount of the PCL in the t outer skin layer is about 0 wt % to about 35 wt % of the total weight of the outer skin layer. For example: the amount of PCL resin in the outer skin layer could be 30 wt %, 20 wt %, 15 wt % or less.

In an embodiment, the polymer blend Y in the outer skin layer further comprises a processing aid, a chain extender, a nucleating agent, a biodegradable promoter, a plasticizer, antiblock particles, inorganic particles and/or slip additives or mixtures thereof,

In an embodiment, the weight of the outer skin layer is an amount of about 1.0 wt % to 25 wt % such as about 5 wt %, 10 wt %, 15 wt %, 20 wt % or more of the total weight of the core layer.

In an embodiment, the composite film comprises only a core which is essentially a monolayer of the base film.

In an embodiment, the composite film comprises a second outer layer.

In an embodiment, the composite film comprises a core layer, a first outer layer, and a second outer layer.

In an embodiment, the second outer skin layer comprises the same materials as the first outer skin layer.

In an embodiment, the second outer skin layer comprises materials different from the first outer skin layer.

In an embodiment, the first outer skin layer comprises the same materials as the core layer.

In an embodiment, the first outer skin layer comprises materials different from that of the core layer.

In an embodiment, wherein the composite film optionally comprises either one or two tie-layers which is located between the core layer and the two outer skin layers.

In an embodiment, the outer skin layers comprise an amount of antiblock particles with a spherical size of about 2 to 6 μm.

In an embodiment, a loading of the antiblock particles in the outer skin layers is in the range of 100 to 5000 ppm of a total weight of the outer skin layers.

In an embodiment, the outer skin layers comprise a migratory slip additive.

In an embodiment, a loading of the migratory slip additive is in the range of 500 to 5000 ppm of a total weight of the outer skin layers.

In an embodiment, the film is configured to be a print film has the core layer comprising migratory particles in an amount of 500 to 1000 ppm.

In an embodiment, the outer skin layer is either a layer of receiving print ink, adhesives, metal deposition or coating.

In an embodiment, the biaxially oriented PHA-rich composite film comprises a heat sealable layer.

In an embodiment, the biaxially oriented PHA-rich composite film comprises no heat sealable layer.

In an embodiment, the thickness of the PHA-rich composite film is about 10 μm to about 80 μm.

In an embodiment, the thickness of the composite film is about 15 μm to about 50 μm.

In an embodiment, the outer skin layers have a thickness of about 1 μm to about 5 μm.

In an embodiment, the skin layers have a thickness of about 1 μm to about 3 μm.

In an embodiment, the skin layers have a thickness of about 1 μm to about 2 μm.

In an embodiment, the biaxially oriented compostable composite film could essentially be used as home compostable packaging materials.

In an embodiment, the core layer comprises TUV-certified home compostable bioplastics at an amount more than 50 wt %, preferably more than 60 wt %, more preferably more than 70 wt % of the total weight of the core layer.

In an embodiment, the outer skin layers comprise TUV-certified home compostable bioplastics at an amount more than 50 wt %, preferably more than 60 wt %, more preferably more than 70 wt % of the total weight of the outer skin layers.

In an embodiment, the biaxially oriented PHA-rich composite film has a low haze less than 12% and a high gloss of above 80 at 60°.

In an embodiment, the PHA-rich composite film has heat shrinkage rate less 5% in machine direction and less than 8% in transverse direction at temperature 120° C. and a duration time 15 minutes.

In an embodiment, inventors disclose the method of making biaxially oriented PHA-rich composite film suitable for the application of packaging, label, printing film and facestocks in which high mechanical properties such as elongation force, tensile strength and Young's modulus are required for the final products.

In an embodiment, the invention provides a method of making PHA-rich composite film which has improved optical properties, and high mechanical properties and home compostability.

### BRIEF DESCRIPTION OF THE FIGURES

The foregoing summary, as well as the following detailed description of various embodiments, is better understood when read in conjunction with the appended drawings. For the purposes of illustration, drawings show an exemplary embodiment; however, the presently disclosed subject matter is not limited to the specific methods and instrumentalities disclosed. In the drawings:

FIG. 1 shows the cross-sectional view of a biaxially oriented PHA-rich home compostable film with a core layer, a first outer skin layer, and a second outer skin layer.

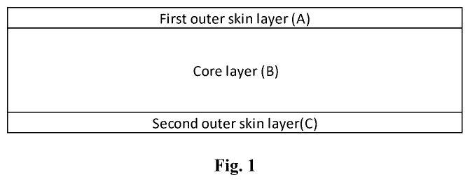

### DETAILED DESCRIPTION

### Definitions and General Techniques

For simplicity and clarity of illustration, the figures illustrate the general manner of construction, and descriptions and details of well-known features and techniques may be omitted to avoid unnecessarily obscuring the present disclosure. Additionally, elements in the figures are not necessarily drawn to scale. For example, the dimensions of some of the elements in the figures may be exaggerated relative to other elements to help improve understanding of embodiments of the present disclosure. The same reference numerals in different figures denote the same elements.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Unless otherwise defined herein, scientific and technical terms used in connection with the present invention shall have meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

“Polymer” is a macromolecule compound prepared by polymerizing monomers of the same or different type. Polymer includes homopolymers, copolymers, terpolymers, tetrapolymer, and so on. “Homopolymer” is a polymer by polymerizing one monomer and has the same repeating unit in the polymer chain. “Copolymer” is a polymer derived from more than one species of monomers or comonomers. “Terpolymer” is a polymer made by polymerizing three different monomers and “Tetrapolymer” is a polymer by polymerizing four different monomers, and so on.

In an embodiment, polymers could include additional additives. The polymer is interchangeably used as “resin”.

“Biaxially oriented film” is a film that is stretched in both machine and transverse directions, producing molecular chain orientation sequentially or simultaneously in two directions. A biaxially oriented film has much higher tensile strength and Young's modulus in comparison with a non-oriented co-extruded film or a blown film which is mainly oriented in machine direction. In addition, a blown film can also have high heat shrinkage in machine direction. The biaxially oriented film could be a single layer or multi-layer composite film.

“Biodegradable Bioplastics” or “Biodegradable Film” or “Biodegradable composite film” or “Compostable Composite Film” or “Compostable label film” or similar refer to polymeric materials that are ‘capable of undergoing decomposition into carbon dioxide, methane, water, inorganic compounds, or biomass in which the predominant mechanism is the enzymatic action of microorganisms, that can be measured by standardized tests, in a specified period of time, reflecting available disposal condition’. In an embodiment, more than 50%, 60%, 70%, 80%, 90% of the film could be degraded by the microbial action within the prescribed period. In an embodiment, the film could be fully degraded by the microbial action. In an embodiment, the biodegradable film has a home composting property as described by AS 5810-2010 standard.

Other certifications or regulatory authorities, for the biodegradability and/or disintegration standards are ISO 20200 or various similar standards for home compostability (e.g., NF T51-800 (2015); or the OK Compost Home Certification scheme of TUV Austria Belgium).

“Semi-crystalline” or “semicrystalline” refers to a polymer that exhibits highly organized and tightly packed molecular chains. “Semi-crystalline” may be simplified as “crystalline” as in comparison with “amorphous”. The crystalline regions are called spherulites and can vary in shape and size with amorphous regions existing between the crystalline regions. As a result, this highly organized molecular structure has a defined melting temperature point.

“Crystallinity” refers to the degree of highly organized order structure excluding the fraction of amorphous phases in a resin. Typically, a semi-crystalline resin has a degree of crystallinity in the range of from 10 wt % to 80 wt % of the total weight of the resin.

The crystallinity of a PHA resin is calculated from the heat of fusion of the PHB resin and the heat of fusion ΔH° 146 J/g of perfect PHB crystals (Journal of Biomaterials and Nanobiotechnology 2011; 2; 301 to 310, herein reference is listed for convenience).

The crystallinity of PLA resins is calculated from the heat of fusion 93.6 J/g which is the heat of fusion for 100% crystalline PLA crystals (polylactic acid) (J Polym Environ 2001; 9: 63-84, herein reference is listed for convenience.

“Total crystallinity” refers to the crystallinity of a polymer blend or composite containing more than one component. The degree of the crystallinity of each component can be measured by using differential scanning calorimetry (DSC). The degree of the crystallinity of a polymer blend or composite can also be determined by using DSC experiment. If a composite comprises 40 wt % Y1000P (PHBV), 30 wt % BP330-05 (PHB-co-3HHx), and 30 wt % PLA4043 (PLA) resins, wherein the crystallinity of Y1000P, BP330-05 and PLA4043D is about 73 wt %, 38 wt %, and 41 wt %, respectively. The total crystallinity of the composite is about 40.6 wt % which can be obtained from calculation.

“Amorphous resin” has a randomly ordered molecular structure which does not have a sharp melting temperature point. Such a resin often softens or solidifies as its temperature is changed to above Tg or below Tg.

“Glass transition temperature, Tg” is a thermal property associated with the long-range segmental mobility of polymer chains. As the temperature increases above Tg, a resin starts softening; as the temperature drops below Tg, the resin starts solidifying.

Tg governs the rigidity, toughness and flexibility of a polymer or polymer composite in a specific temperature range. Under ambient temperature condition, a polymer film with a Tg higher than ambient temperature, it is rigid, otherwise it is flexible as it has a Tg below ambient temperature. Either DSC or DMA (dynamic mechanical analysis) can be used to determine the Tg of polymers, polymer blends, composites, and multilayer plastic films.

“Low Tg flexible biopolymers” in the invention refer to those biopolymers have a Tg less than 10° C., including PBSA, PBS and PCL, PBAT, and PHA resins, but PHB and PHBV are excluded. Although PHB or PHBV biopolymers have a Tg lower than 10° C., they are rigid biopolymers due to their high crystallinity.

“Modifier” refers to materials that are added into the resin to improve the properties of a biaxially oriented composite film such as but not limited to improving mechanical strength (flexibility, modulus, tensile strength, elongation, etc.), thermal stability, biodegradability, compostability, optical properties, and surface properties, heat sealing properties and so on. In an embodiment, modifier could be added in the resin during an appropriate step of polymerization, melt compounding, dry blending and coextrusion processes at a desirable amount.

“Modifier X” is a non-PHA based modifier used to modify the core layer. Modifier X comprises biopolymers having a glass transition temperature of Tg≤60° C. It includes for example but not limited to PBS, PBSA, PCL, PBAT, PLA, and PLA copolymers such as PLA-co-GA, PLA-co-3HP, and PLA-co-B-CL copolymers.

“Polymeric blend Y” is a mixture of biopolymers used in the outer skin layer other than PLA resins. The biopolymers Y have glass transition temperatures of Tg≤10° C. and melting points between 56 to 180° C. The polymer blend Y includes but not limited to PHA resins, PBSA resins, PCL resins, or other biodegradable polymers or mixtures thereof.

“PHA-rich” is defined when the content of PHAs is more than 50 wt % in the total weight of the polymeric resin in the layer. Therefore, a PHA-rich composite film has a core layer comprising PHA resins not less than 50 wt % of the total weight of the polymeric resin in the core layer.

“PLA resin” is polymerized from a racemic mixture of L- and D-lactides with the level of (L) and (D) monomers being variable. The crystallinity of PLA resins (including L-dominated PLLA and D-dominated PDLA) can be controlled by the ratio of L and D monomers in PLA chain structure.

“Peak melting temperature” refers to the average melting temperature (Tm) of the crystallites of a semi-crystalline polymer. The Tm of a semi-crystalline polymer is obtained by measuring a polymer sample well annealed at its crystallization temperature using DSC at a heating rate of 10° C./min.

“Shrink film” refers to a plastic film which shrinks tightly over whatever it is covering due to high heat shrinkage rate when heat is applied to it. Shrink film can be used for either packaging film or shrinkable film. Usually, a shrink film has a percentage of the amount of shrink measured in both the machine direction (MD) and the transverse direction (TD) above 20%.

“Non-shrink film” usually refers to a plastic film which is stretchy and requires no heat application. Stretching tension and cling of a plastic film provide tightness required for packaging.

“Heat resistant film” refers to a plastic film which has heat shrinkage rate less than 10% in both machine direction and transverse direction when processing heat such as metallizing, printing, coating, laminating or heat sealing is applied to it. The characteristics of heat resistance is required for food packaging as well as label film.

### Materials and Properties

### PHA Resins

In an embodiment, Polyhydroxyalkanoates (PHA) resin has a copolymer structure of poly((3HB)ₙ-co-(mHZ)₍₁₋ₙ₎), where H=hydroxy; B=butylene; m is the position number of hydroxy group on the carbon chain of alkanoic acid (m=3 or 4 or 5); Z is the alkanoate in the copolymer (Z=Valerate (V), Hexanoate (Hx), Octanoate (O), and Decanoate (D) or mixtures thereof); n is the mole percentage of 3HB and (1−n) is the mole percentage of mHZ in the copolymer structure. The n value of semi-crystalline PHA resins is usually in the range of 85 to 100 mol %, and the (1−n) value is in the range of 0 to 15 mol %. As (n−1) is higher than 50 mol %, random PHA copolymers might become amorphous. Both the mole percentage (3HB and mHZ) and the structure of mHZ dominate the basic properties of PHA resins, especially, the crystallinity and melting temperature of the PHA resins. As n=1, the PHA resin is a PHB (or P3HB) homopolymer. PHB homopolymer has a Tg about 0 to 10° C. and a melting temperature of 173 to 178° C. It is a very rigid biopolymer due to its high crystallinity (about 80%). PHA resins have a Tg in the range of −44° C.≤Tg≤10° C. and a Tm of in the range of about 120 to 178° C. (Appl. Sci. 2017, 7, 242, herein reference is listed for convenience). Amorphous PHA resins comprise a high mole ratio of mHZ monomer so that the PHA copolymers has a Tg less than ≤−10° C., they are very rubbery biopolymers. Common engineering PHA biopolymers include PHB, PHBV, PHB-co-3HHx, PHB-co-4HHx, PHB-co-3HO, and PHB-co-3HD.

Commercialized PHA copolymers mainly comprise 85 to 100 mol % of 3-hydroxy butyric acid monomer and 0 to 15% other comonomers. PHA copolymers include P3HB-co-3HHx which is a copolymer of 3-hydroxybutyrate and 3-hydroxyhexanoate; P3HB-co-4HHx which is a copolymer of 3-hydroxybutyrate and 4-hydroxyhexanoate; P3HB-co-4HB which is a copolymer of 3-hydroxybutyrate and 4-hydroxybutyrate; P3HB-co-3HO which is a copolymer of 3-hydroxybutyrate and 3-hydroxyoctanoate(3HO).

Example of PHBV resins include TianAn Enmat™ Y1000P, poly(3-hydroxybutyrate-co-3-hydroxyvalerate) (PHB-co-3HV or PHBV). An amount of from about 0.5 to 1 mol % 3hydroxyvaleric acid comonomer (3HV) obtained from petroleum-based chemicals as a precursor was added into feedstock in fermentation process to synthesize the copolyester of PHBV. The short side chain (ethyl group CH₂CH₃) of 3HV can be incorporated into PHB crystals, leading to a high melting point of 173° C. and a high crystallinity (73%) according to the data obtained from differential scanning calorimetry (DSC) experiment. Y1000P has a glass transition temperature of about 2° C. and a melt flow index 8 to 15 g/10 min. at the condition of 190° C. and 2.16 Kg, and a density of 1.25 g/cm³. Y1000P is a very rigid biopolymer due to its high crystallinity. The PHBV copolymer performs the same as the PHB homopolymer due to their similarity of polymer chain structure in solid state.

Example of PHB-co-3HHx polymers includes Bluepha™BP330-05 resin which has a melt flow rate of about 6.3 g/10 min. at the condition of 165° C. and 2.16 Kg and a melting temperature of about 149° C. and a crystallinity of about 38%.

In an embodiment, the optimal crystallinity of PHA resins used in the core layer in the invention is higher than 35% to improve rigidity and Young's modulus. Preferably, optimal melting temperature of the PHA resins is higher than 145° C. It has been reported that PHA resins with a high percentage of side chains longer than three carbons including side chains 3-hydroxyhexanoate(3HHx), 3-hydroxyoctanoate(3HO), and 3-hydroxydecanoate (3HD) have a crystallinity in the range of about 35 to 42%, those PHA resins are flexible due to the characteristics of glass temperatures in the range of about −3 to 3° C., those PHA resins have Young's modulus at the levels of oriented HDPE films, which is much lower than that of BOPP film used in packaging and label film.

It has been noted that biaxially oriented HDPE film is insufficient in both tensile strength and Young's modulus to replace BOPP packaging and label film materials in the market. Optimal Young's modulus for desirable packaging and label film needs to reach or close the modulus levels of BOPP films. In comparison, the crystallinity of homopolypropylene resins used in the market is about in the range of 60 to 70 wt %, which is much higher than that of PHA resins (35 to 42%) with longer side chains. In addition, the melting temperature of homopolypropylene is in the range of 160 to 170° C., which is much higher than that of flexible PHA resins (125 to 150° C.) with longer side chain. Both the lower crystallinity and low melting temperature of flexible PHA resins (Tg is about in the same as that of homopolypropylene, about −5 to 5° C.) with longer side chain result in lower heat resistance and higher heat shrinkage.

### PLA Resins

In an embodiment, PLA resin is considered as a rigid biopolymer with high stiffness due to its high glass temperature at about 56° C. PLA resin is available at large commercial scale with a relative low cost, therefore, PLA resins are excellent candidates to be used to enhance the stiffness, tensile strength, and Young's modulus of PHA-rich biofilms.

In an embodiment, optimal tensile strength and Young's modulus are required for snack food packaging and label film. The tensile strength and stiffness/flexibility of the composite film can be controlled by balancing the ratio of rigid/flexible components in the core layer.

Examples of PLA resins include NatureWorks Ingeo™ PLA4032D and PLA4043D or PLA2003D or TotalEnergies Corbion Luminy® LX575 and LX175. These resins have a melt flow rate of about 3.9-4.1 g/10 min. at 190° C./2.16 Kg test condition, a melting temperature of about 145-170° C., a glass transition temperature of about 55-60° C., a density of about 1.25 g/cm³. Molecular weight Mw is typically about 200,000 g/mole; Mn typically about 100,000 g/mole; polydispersity about 2.0. PLA4032D and LX575 has a melting point of about 165-173° C., which are more preferred crystalline PLA resins for thermal resistance application.

In an embodiment, Ingeo™ PLA4043D and Luminy® LX175 has a melting point of about 145-152° C., lower Tm melting temperature of those PLA resins have the advantages of the capability of melting at lower extrusion temperatures as blended with biopolymers with poor thermal stability such as PHA resins. PLA resins with a Tm of about 150° C. such as LX175 and PLA4043D melt earlier compared to those PLA resins with a Tm of about 165° C. such as LX575 and PLA40432D before PHA resin melts during extrusion.

Semi-crystalline PLA resins could be used as they are in amorphous state and are not crystallized before extrusion. Amorphous PLA resins can soften at lower temperatures (at Tg about 56° C.) and lubricate extrusion and facilitate the melting of PHA resins especially PHB or PHBV resins which have a Tm in the range of from 150 to 178° C., as a result, the extent of PHA thermal degradation can be extremely eliminated. Amorphous semi-crystalline PLA resins can crystallize afterwards during film orientation processes. Therefore, starting with amorphous semi-crystalline PLA resins will not change the properties of final PHA-rich film products.

In an embodiment, amorphous PLA resins include NatureWorks Ingeo™ 4060D and TotalEnergies Corbion Luminy® LX975. Those resins have a melt flow index of about 3 to 6 g/10 min. measured at the condition of 2.16 Kg/190° C., and a glass transition temperature Tg of about 52-60° C. (softening temperature), heat seal initiation temperature of about 93° C., a density of about 1.24 g/cm³. Molecular weight Mw is about 180,000 g/mole. As it has been well known in the art that there are no melting temperatures for amorphous PLA resins. As amorphous PLA resins are heated to their glass transition temperature Tg around 56° C., the PLA chains can flow, and form entanglements, which create seals (solidifying) as the PLA chains are cooled to the temperatures lower than Tg 56° C.

### High MFR PLA Resins for Outer Skin Layer

PLA resins with a high melt flow rate (MFR) of 8 to 15 g/10 min. (tested at the condition of 190° C. and 2.16 Kg) are usually used for application of injection molding per manufacturer recommendation. The melt flow rate (or melt flow index) of thermoplastic PLA resins not only indicates the molecular weight but also the flow characteristics of a melted PLA resin. PLA resins with a higher MFR are more prone to flow during injection molding, having a lower chance to form defects such as flow marks. Surprisingly, PLA resins for injection molding could be used in the outer skin layers to improve optical properties in film making. The method of using high MFR PLA resins in the outer skin layers resolves the issue of high haze and low glosses observed for biaxially oriented PHA-rich composite film.

Suitable examples of high MFR semi-crystalline PLA resins include Luminy® LX530 and, Ingeo™3801X, and Ingeo™ 3052D, which have a melt flow rate in the range of 8 to 15 g/10 min. at the test condition of 190° C. and 2.16 Kg and a melting temperature of 145 to 170° C. Those PLA resins in the outer skin layer as modifier could provide the crystallinity and heat resistance required for printing, coating, and metallization.

Suitable examples of high MFR amorphous PLA resins include Luminy® LX930 and Ingeo™ 6060D, which have a melt flow rate in the range of 8 to 15 g/10 min. at the test condition of 190° C. and 2.16 Kg. Those amorphous PLA resins as modifier in the outer skin layers could provide heat sealability together with PBSA and PCL resin. High MFR amorphous PLA resins could improve mixing between PLA and other components so that the flowability was improved, resulting in improved film optical properties. In addition, it is believed that amorphous PLA resins could biodegrade faster than that their semi-crystalline counterparts.

### PBSA Resin

One suitable example of PBSA resins could be but not limited to PTT MCC BioPBS™ FD92PM, which has a glass transition temperature (Tg) −47° C. and a melting temperature (Tm) 87° C., and a melt flow index about 4 g/10 min. at 2.16 Kg/190° C. standard condition. The heat of fusion for PBSA was referred to its homopolymer PBS which is a highly crystalline polymer exhibiting a melting point (Tₘ) of 114.1° C. and heat of fusion of 68.4 J/g. FD92PM resin is a TUV-certified biopolymer for industrial and home composting application.

### PCL Resin

One suitable example of PCL resins could be but not limited to Ingevity CAPA®6500D, which has a glass transition temperature (Tg) about −60° C. and a melting temperature (Tm) about 58° C. The melt flow index is about 29 g/10 min. at the test condition of 190° C./2.16 Kg. Preferably, the content of CAPA6800D is less than 35 wt %. High PCL loading in the outer skin layer are prone to form film blocking. The heat of fusion of 100% crystalline PCL is about 135.3 J/g. Those biodegradable polymers are TUV-certified for both industrial composting and home composting.

### Other Polymers and Additives

In an embodiment, a suitable example of PBAT (Poly(butylene adipate-co-butylene-terephthalate) (PBAT) resins includes not limited BASF Ecoflex® C1200, which has a density of about 1.25 g/cm³, a glass transition temperature of about −30° C., a melt flow index of about 4/10 min. at the condition of 2.16 Kg/190° C.

In an embodiment, multi-functional epoxidized or maleic anhydride grafted polymeric resins can chemically react with the chain end groups (—COOH) of polyesters. One suitable example of multi-functional reactive polymeric resins with the functional groups include Dow Biomax® SG 120 resin. It has a contemplated structure of ethylene-n-butyl acrylate-glycidyl methacrylate, ethylene-methyl acrylate-glycidyl methacrylate, ethylene-glycidyl methacrylate, or blends thereof. This additive has a density of about 0.94 g/cm3, a melt flow rate of about 12 g/10 min. at 190° C./2.16 kg test condition, a melting point of about 72° C., and a glass transition temperature of about −55° C.

In an embodiment, spherical antiblocks are necessary for film making. The spherical antiblocks includes crosslinked silicone polymer such as Tospearl® grades of polymethylsilsesquioxane of nominal 2.0 and 3.0 μm sizes and sodium aluminum calcium silicates of nominal 3 μm or 5 μm in diameter (such as Mistui Silton® JC-30 and JC-50).

In an embodiment, PLA10A is an antiblock masterbatch comprising 5 wt % Silton® JC-30 particles and 95 wt % amorphous PLA carrier resin Luminy®LX975. PLA10A was made through toll compounding.

In an embodiment, migratory slip additives may also be contemplated to control COF properties such as fatty amides (e.g. erucamide, stearamide, oleamide, etc.) or silicone oils ranging from low molecular weight oils to ultrahigh molecular weight polysiloxane gums.

### Film Preparation

In an embodiment, the multilayer composite film is a three-layer film comprising a PHA-rich core layer sandwiched by two outer skin layers, the core layer is considered as the base layer to provide the bulk strength and mechanical properties of the oriented PHA-rich composite film.

In an embodiment, the core layer (B) comprises PHA resin at an amount of more than 50 wt % of the total weight of the core layer and non-PHA based modifier X at an amount of less than 50 wt % of the total weight of the core layer.

In an embodiment, the PHA resins in the core layer include semi-crystalline PHA resins with a glass transition temperature of Tg≤10° C. and a melting temperature in the range of 140 to 180° C. Preferably, the crystallinity of the PHA resins in the core layer is higher than 35%.

In an embodiment, the modifier X in the core layer comprises biopolymers including PLA, PLA copolymers, PBS, PBSA, PCL resins, PLA copolymers include PLA-co-3HP, PLA-co-B-CL and PLA-co-GA resins having a glass transition temperature of Tg≤60° C. and a melting temperature Tm in the range of from 56° C.≤Tm≤170° C., preferably, the Tm is in the range of from 56 to 155° C.

In one embodiment, the core layer (B) can include processing aids, antioxidants, plasticizers, nucleating agents, inorganic particles, fillers, lubricants and slip additives.

In an embodiment, a small amount of chain extenders, plasticizers, nucleating agents, slip additives or mixtures thereof could be added into the core layer as rheology modifier to improve the processability of the composite film.

In an embodiment, the PHA-rich composite film is a monolayer film with a formulation of the core layer described above.

In an embodiment, the composite film comprises a first outer skin layer (A) which is on the top of the core layer.

In an embodiment, the first outer skin layer (A) comprises PLA resin at an amount less than 50 wt % and polymeric blend Y at an amount of about 50 wt % to 100 wt % of the total weight of the first outer skin layer.

In an embodiment, the PLA resin in the first outer skin layer comprise semi-crystalline PLA resin, amorphous PLA resin and PLA copolymers with a melt flow index of 3 to 15 g/10 min. at the test condition of 190° C. and 2.16 Kg.

In an embodiment, the polymer blend Y comprises PHA resins or polybutylene succinate (PBS) or polybutylene succinate-co-adipate (PBSA) or polycaprolactone (PCL) resins or mixtures thereof.

In an embodiment, the polymer blend Y comprises PHA resins at an amount of 0 to 90 wt % of the total weight of the outer layer.

In one embodiment, the polymeric blend Y comprises PBSA resins at an amount of 0 to 90 wt % of the total weight of the outer layer.

In one embodiment, the polymeric blend Y comprises PCL resins at an amount of 0 to 35 wt % of the total weight of the outer skin layer.

In an embodiment, the first outer skin layer comprises a desirable amount of antiblocks and slip additive for slip and blocking control. Antiblock components could be selected from the group consisting of amorphous silicas, aluminosilicates, sodium calcium aluminum silicates, crosslinked silicone polymers, and polymethylmethacrylates to aid in machinability and winding and to lower coefficient of friction (COF) properties. Suitable amounts range from 0.03 to 2 wt % of the heat sealable layer and typical particle sizes of 2.0-6.0 μm in diameter, depending on the final thickness of this layer. A suitable amounts of slip additives can also be included at an amount in the range from 300 ppm to 10,000 ppm of the layer.

In an embodiment, if heat sealing is required for the outer skin layers, a combination of amorphous PLA resin, PBSA and PCL in the desirable loading range has been found not only to sufficiently lower the seal initiation temperature, broaden the heat sealing temperature window, and enhance the plateau seal strength, but also maintain the processability during film-making as well as to help keep the sealant layer home compostable since heat sealable amorphous PLA resin is not home compostable. The quick disintegration of the sealant layer resulted from improved compostability may help the compostability of the total film structure of a composite film product.

In an embodiment, the composite film comprises a second outer skin layer (C) on the bottom of the core layer (B), opposite the first outer skin layer (A).

In an embodiment, the second outer skin layer could have the same formulation as the first outer skin layer.

In an embodiment, the second outer skin layer could have a formulation different from that of the first outer skin layer.

In an embodiment, the outer skin layers of the composite film could be formulated for the purpose of heat sealable layer, print ink receiving layer, metal receiving layer or coating receiving layer.

If desired, all three layers of the film could comprise the same materials, thus rendering the overall multi-layer film a monolayer composite film.

If desired, in an embodiment, the outer skin layers could be discharge-treated with the skills well known in the art for lamination, metallizing, printing, or coating. Discharge-treatment in the above embodiments can be accomplished by several means, including but not limited to corona, flame, plasma, or corona in a controlled atmosphere of selected gases.

In an embodiment, this invention provides a method to allow the production of biaxially oriented PHA-rich composite film with improved optical properties, high elongation force, and tensile strength and Young's modulus.

### EXAMPLES

This invention will be better understood with reference to the following examples, which are intended to illustrate specific embodiments within the overall scope of the invention.

The thermal properties as well as melt flow rates of the biopolymers used in Examples are showed in Table 1. The glass transition temperature Tg and melting temperature Tm of the biopolymers are obtained from DSC experiments on the materials. The heat of fusion of the biopolymers measured through DSC experiments was used to determine the crystallinity (Xc) of the biopolymers according to the heat of fusion of the perfect crystals of those biopolymers obtained from literature.

The compositions of each layer of the coextruded composite films made in Examples are shown in Table 2a, 2b and 2c.

The multi-layer composite film was made using a process of coextrusion and sequential orientation. The coextrusion was conducted at temperatures of about 160° C. to 210° C. by pushing materials through a flat die, cast the polymer curtain at a desirable casting speed on a chill drum with temperatures controlled between 15° C. and 35° C. using an electrostatic pinner, and then oriented in the machine direction 2 to 3.5 times through a series of heated and differentially sped rolls controlled at about 50° C. to 70° C., followed by transverse direction stretching about 3 to 5.0 times in a tenter oven with temperatures controlled at about 75° C. to 90° C. and then annealed at about 90° C. to 140° C. to reduce internal stresses to minimize shrinkage and give a relatively thermally stable biaxially oriented sheet. It is also beneficial to relax about 5 to 15% of the maximum width of the tenter orientation in the stretching section.

A three-layer coextruded biaxially oriented PLA film (BOPLA) was made as control using sequential orientation on a 12-inch-wide flat die line as described previously, including non-heat sealable layer (A), a core layer (B), a heat sealable layer (C). The core layer was sandwiched between two outer skin layers. The PLA10A is a 5 wt % JC-30 (silica particles) masterbatch in 95 wt % LX975 carrier resin. PLA10A was added into outer skin layers for the purpose of COF control and anti-blocking. The content of JC-30 particles in the non-heat sealable outer layer (A) is about 500 ppm and the content of JC-30 antiblock in the heat seal layer (C) is about 3000 ppm.

The dry blended resins of the core layer and the outer skin layers were melt coextruded individually in extruders A (first outer layer, cast side layer), B (core layer) and C (second outer layer, heat sealant layer) at temperatures of about 204° C. The molten resins flowed through a set of screen pats and individual melt pipes and then met inside the die body of a twelve-inch flat die set at temperature of about 204° C., resulting in a curtain of molten resin. In general, the residence time of polymer melt between the entrance of each extruder and the exit of the die body was estimated at about 10 to 15 min., varying with the rpm of extruders and the length of pipes. The resin curtain was then cast on a chilled drum (set at temperature about 30° C.) using an electrostatic pinner. The formed cast sheet was stretched 2.8 times in the machine direction (MD) through rolls set at temperatures between 40° C. to 65° C. and then stretched 5.3 times in transverse direction (TD) in a tenter oven set temperatures 65 to 82° C. The resultant biaxially oriented film was subsequently heat set at about 138° C. and then relaxed at about 10% in TD, followed by discharge-treated on the surface of the non-heat sealable skin layer (A) by corona treatment. The film was then wound up in roll form.

The total thickness of this PLA control film was about 20 μm. The thickness of the respective heat sealable resin layer (C) after biaxial orientation was about 2.0 μm. The thickness of the core layer (B) after biaxial orientation was about 17.0 μm. The thickness of the non-sealable skin layer (A) was about 1.0 μm.

### Example 2

Example 1 was repeated while the process conditions and formulations were changed. The core layer was changed to a blend of about 60 wt % PHBV Y1000P resin and 40 wt % oLX175 resins. An optimum reverse extrusion temperature profile from high at about 193° C. to low at about 160° C. was used in extrusion. The melt pipe temperature of the extruder B was controlled at not higher than 165° C., at which thermal degradation observed for PHA resins starts. The formulation for the first outer skin layer A was changed to a blend of about 24 wt % LX975, 70 wt % FD92PM, and 6 wt % PLA10A; and the formulation for the second outer skin layer C was changed to a blend of about 34 wt % LX975, 50 wt % FD92PM, 10 wt % CAPA6500D, and 6 wt % PLA10A. The core layer and both outer skin layers comprised about 60 wt % TUV-certified home compostable biopolymers. There is no PHA resin in the outer skin layers.

The extrusion temperatures of extruders for layers A and C were at about 193° C. The temperature of the die body was set at about 175° C. The molten polymer melt was cast on a chilled roll set at about 30° C. to form a cast sheet with a width about 9.5 inches. The sheet was oriented in machine direction for 2.8 times and then in transverse direction for 4.5 times. The composite film was heat set at 137° C. and relaxed for 10% in TD and then corona-treated under conditions described previously. The thickness of the coextruded oriented laminate film is about 15 μm.

### Example 3

Example 2 was repeated, and the content of Y1000P resin in the core layer was increased to about 70 wt % and LX175 PLA resin was reduced to about 30 wt %. The formulation for the first outer skin layer A was changed to a blend of about 24 wt % LX975, 60 wt % FD92PM, 10 wt % CAPA6500D, and 6 wt % PLA10A, the outer skin layers of the composite film have the same recipes. The heat set temperature was reduced to about 104° C. The film thickness is about 24 μm.

The PHA-rich composite film has about 70 wt % TUV-certified home compostable biopolymers in all three layers. There is no PHA resin in the outer skin layers.

The PHA-rich composite film in Examples 2 to 3 is two-side heat sealable.

### Example 4

Example 2 was repeated, the recipe of the core layer was changed to a blend of 60 wt % BP330-05 and 40 wt % PLA4043D. The recipes of the outer skin layers A and C were changed to a blend of 70 wt % BP330-05, 29 wt % PLA4043D and 1 wt % PLA10A. The extrusion temperatures for the outer skin layers were changed to a similar profile of the core layer to avoid potential thermal degradation for BP330-05 resin during extrusion. The heat set temperature was changed to about 127° C. The film thickness is about 29 μm.

### Example 5

Example 4 was repeated, the recipe of the second outer skin layer C was changed to a melt blend compound with about 34 wt % LX930, 50 wt % FD923PM, 10 wt % CAPA6500D and 6 wt % PLA10A. There was no change for the recipes of the core layer and the first outer skin layer A. The film has a thickness of about 20 μm. Amorphous PLA resin LX930 has a high MFR of 11.5 g/10 min. at the test condition of 190° C./2.16 Kg.

### Example 6

Example 4 was repeated, the recipes of two outer skin layers were changed to a blend of 70 wt % BP330-05, 29 wt % LX530 and 1 wt % PLA10A. There was no change in other conditions. The film thickness is about 23 μm. Semi-crystalline PLA resin LX530 has a high MFR of 9.3 g/10 min. at the test condition of 190° C./2.16 Kg.

### Example 7

Example 7 was made at a different pilot line with a flat die about 17 inches wide. The line was armed with two twin screw extruders and die block able to make A/B/A film structure. The core layer was extruded from main extruder. The outer skin resin was extruded from a coex extruder and then split in the die block to form two outer skin layers with the same recipe and about the same skin thickness. The polymer melt curtain was cast and then oriented in machine direction and then in transverse direction. The recipe of the core layer was the same as that in Example 6, while the recipe of the outer skin layers was changed to a blend of about 60 wt % FD92PM, 39 wt % LX175 and 1 wt % PLA10A. After the composite film was oriented 2.6 times in machine direction and 4.5 times in transverse direction, it was heat set at about 127° C. and then relaxed for about 10% in transverse direction. The coextruded oriented composite film has a thickness of about 49 μm. This is an example of making a thicker PHA-rich composite film. There are about 60 wt % TUV-certified home compostable biopolymers in all three layers. There is no PHA resin in the outer skin layers.

### Example 8

Example 7 was repeated except that the recipe of the two outer layers was changed to a blend of 70 wt % BP330-05 and 30 wt % PLA4043D. The film has a thickness of about 34 μm.

### Example 9

Example 8 was repeated, except that the core layer was changed to a blend of 70 wt % BP330-05 and 30 wt % PLA4043D. The film has a thickness of about 33 μm.

TABLE 1
MFR and thermal properties of biopolymers in Examples

| Thermal properties of semi-crystalline biopolymers | | | | | | | TUV-certified |
|---|---|---|---|---|---|---|---|
| | Resin | MFR | Tg | Tm | ΔH | Xc | for Home |
| Grade | type | (g/10 min.) | (° C.) | (° C.) | (J/g) | (%) | Compostable |
| LX575 | PLA | 3.9 | 56 | 166 | 35 | 37 | No |
| LX175 | PLA | 4.3 | 56 | 152 | 36 | 38 | No |
| LX530 | PLA | 9.3 | 56 | 163 | 37 | 40 | No |
| LX930 | PLA | 11.5 | 56 | NA | | | No |
| LX975 | PLA | 5.3 | 56 | NA | | | No |
| PLA4043D | PLA | 5.9 | 56 | 150 | 34 | 36 | No |
| Y1000P | PHA | 12.1 | 2 | 173 | 106 | 73 | Yes |
| BP330-05 | PHA | 6.3 | −4 | 149 | 56 | 38 | Yes |
| FD92PM | PBSA | 4.9 | −47 | 87 | 42 | 61 | Yes |
| CAPA6500D | PCL | 29 | −60 | 59.4 | 70.1 | 52 | Yes |

TABLE 2a
The composition of the core layer of
the PHA-rich composite films in Examples (“Ex.”)
Composition of core layer (B)-wt %

| | Ex. | Ex. | Ex. | Ex. | Ex. | Ex. | Ex. | Ex. | Ex. |
|---|---|---|---|---|---|---|---|---|---|
| Example | 1 | 2 | 3 | 4 | 5 | 6 | 7 | 8 | 9 |
| LX575 | 81 | | | | | | | | |
| LX975 | 15 | | | | | | | | |
| LX175 | | 40 | 30 | | | | | | |
| PLA4043D | | | | 40 | 40 | 40 | 40 | 40 | 30 |
| Y1000P | | 60 | 70 | | | | | | |
| BP330-05 | | | | 60 | 60 | 60 | 60 | 60 | 70 |
| Biomax | 4 | | | | | | | | |
| SG120 | | | | | | | | | |

TABLE 2b
The composition of the first outer skin layer of
the PHA-rich composite films in Examples (“Ex.”)
Composition of first outer layer (A, cast side)-wt %

| | Ex. | Ex. | Ex. | Ex. | Ex. | Ex. | Ex. | Ex. | Ex. |
|---|---|---|---|---|---|---|---|---|---|
| Resin | 1 | 2 | 3 | 4 | 5 | 6 | 7 | 8 | 9 |
| PLA10A | 1 | 6 | 6 | 1 | 1 | 1 | 1 | | |
| LX175 | 84 | | | | | | 39 | | |
| LX975 | 15 | 24 | 24 | | | | | | |
| FD92PM | | 70 | 60 | | | | 60 | | |
| CAPA ™ | | | | | | | | | |
| 6500D | | | 10 | | | | | | |
| BP330-05 | | | | 70 | 70 | 70 | | 70 | 70 |
| PLA4043D | | | | 29 | 29 | | | 30 | 30 |
| LX530 | | | | | | 29 | | | |

TABLE 2c
The composition of the second outer skin layer of
the PHA-rich composite film in Examples (“Ex.”)
Composition of second outer layer (C, air side)- wt %

| | Ex. | Ex. | Ex. | Ex. | Ex. | Ex. | Ex. | Ex. | Ex. |
|---|---|---|---|---|---|---|---|---|---|
| Resin | 1 | 2 | 3 | 4 | 5 | 6 | 7 | 8 | 9 |
| PLA10A | 6 | 6 | 6 | 1 | 6 | 1 | 1 | | |
| LX975 | 34 | 24 | 24 | | | | | | |
| FD92PM | 50 | 60 | 60 | | 50 | | 60 | | |
| CAPA ™ | 10 | 10 | 10 | | 10 | | | | |
| 6500D | | | | | | | | | |
| BP330-05 | | | | 70 | | 70 | | 70 | 70 |
| PLA4043D | | | | 29 | | | | 30 | 30 |
| LX530 | | | | | | 29 | | | |
| LX930 | | | | | 34 | | | | |
| LX175 | | | | | | | 39 | | |

### Film Properties

The biaxially oriented coextruded PHA-rich composite films were tested for the properties of optical properties, mechanical strength, tear resistance, heat shrinkage (heat resistance), and COF, printability which are basic film properties required for packaging film and label films.

The mechanical strength and tear resistance of the PHA-rich composite films made in Examples were shown in Table 3. A typical BOPP film was included for comparison, which was obtained from a commercial clear BOPP film (Torayfan® YOR4/70G with a thickness of about 17.5 μm which was made in standard BOPP production line). The properties of a BOPP film would be a good benchmark for biofilm development.

As expected, BOPP film showed much better mechanical properties outperforming most of biofilm samples. The PLA control sample (Ex. 1) showed the highest tensile strength as well as Young's modulus in both MD and TD although it has a soft heat sealable outer layer (C), which can reduce the film modulus and noise.

Examples 2 to 9 comprising a PHA-rich core layer showed a tensile strength at about 70 to 94 MPa in MD and about 115 to 172 MPa in TD, respectively, which are slightly lower than that of BOPLA film showed in Example 1. The Young's modulus of the PHA-rich composite film was about 2500 to 33134 MPa in MD and about 2188 to 4052 MPa in TD which on average are also slightly lower than that of BOPLA film. All PHA-rich composite film samples showed good elongation at break suitable for downstream processability. However, the elongation in TD is much higher than that of BOPP film.

The MD tear strength of the PHA-rich composite films made in Examples is significantly higher than the TD shear strength so that the ratio of tear strength MD/TD is >1. The tear strength in Table 3 was normalized to one mil thick film for comparison. A higher tear strength in machine direction is one of the important properties for composite films.

The PLA control film and PHA-rich composite films were measured for optical properties including the haze and the glosses of both surfaces. The PLA control film showed much lower haze and higher glosses compared to the haze of glosses of the PHA-rich composite films as shown in Table 4. It is believed that there exists a good mixing between amorphous PLA and semi-crystalline PLA resins. Good mixing as well as very similar refractive index of the PLA resins provide better optical properties although the heat sealant layer was blended with FD92PM and CAPA6800D which might have added higher haze to the layer.

The refractive index of PLA, PHA, PBSA and PCL resins is different each other, and it is believed that those biopolymers are not mixable although they have similar polarity. Those factors could attribute to the high haze and low glosses observed for PHA-rich composite films. PHA resins (both Y1000P and BP330-05) are immiscible with PLA resins, forming two different separate phases, and a boundary is formed between two phases with different refractive index.

Large PHA crystals can form in the core layer, and they can be one of the factors of high haze. As a result, high haze was observed the PHA-rich composite films. However, as high MFR PLA resins are blended with PHA resins, it is believed that PLA phases will have better dispersion in the PHA matrix, resulting in improvement in optical properties.

Example 2 has low film thickness about 15 μm but it showed a high haze about 35%, the glosses of A and B sides are also very low. Example 3 showed a reduced haze and improved glosses probably due to its much lower heat set temperature and the blending ratio in the core layer, leading to a high heat shrinkage rate.

Examples 4, 5 and 6 showed a trend of reducing haze from about 23% to about 7% and increasing glosses from about 42 to about 89 for A side (tested at 60°) and about 9 to 46 (tested at 20°). Apparently, the improvement in optical properties could be attributed to the change of the melt flow rates of PLA resins from the range of about 5 to 6 g/10 min. to the range of about 9 to 12 g//10 min. in the outer skin layers in that there was no change in the core recipe and film making conditions.

Example 7 without PHA resin in the outer skin layers showed a haze about 16% comparable to that of Example 4 but the glosses are higher.

Example 8 without anti-block JC30 in the outer skin layer showed a haze about 22% comparable to that of Example 4. Antiblock particles do not significantly impact film haze.

Example 9 with a high PHA concentration about 70 wt % in the core layer showed a haze higher than that of Example 8. Higher BP330-05 resin in the core layer resulted in a hazier film.

The heat shrinkage for non-shrink film in both MD and TD is less than 10%, more preferably, less than 8%. Table 5 showed that thermal stability of the composite films determined by measuring the heat shrinkage of the composite films made in Examples 1 to 9 at the temperature about 120° C. for a duration time of 15 minutes.

The factors that impact the heat shrinkage of a PHA-rich composite film include the melting temperature and crystallinity of PHA and PLA resin as well as other biopolymers in the film structure. Importantly, the processing parameters such as orientation ratio, relaxation rate, heat set temperature as well as duration of heat set time can also significantly impact the heat shrinkage of a film.

As the stretching ratios of MD and MD are maintained at a suitable range for fair productivity, the heat set temperature has the greatest influence on thermal stability for the same film formulation and structure. The higher heat set temperature is applied to the composite film, the lower heat shrinkage (or higher heat resistance) can be achieved. However, for a specific resin or a composite film formulation, if the heat set temperature is over the up limit of optimal heat set temperature, the film could become very brittle, leading to film breaks in film making or downstream processes (low value in elongation at break).

All PHA-rich composite films showed heat shrinkage at 120° C. lower than 5% in MD and lower than 9% in TD except for Examples 3. Example 3 showed a high heat shrinkage about 12% in MD and about 32% in TD since a much lower heat set temperature about 104° C. was applied to the oriented film, compared to other examples heat set at temperatures I the range of about 127 to 138° C.

A higher melting temperature and total crystallinity of biopolymers in the composite film structure is beneficial to make a composite film with better heat resistance.

Preferably, to make low heat shrink/high heat resistance film with good thermal stability at processing conditions, the heat set temperature of making the PHA-rich composite films is in the range of from 125° C. to 140° C. If the heat set temperature is too high, the composite film will become brittle so that the composite film cold be difficult to process in film making or downstream processes. If the heat set temperature of making the PHA-rich composite films is too low, the film will have high heat shrinkage which are not suitable for the application with the processes of printing, coating, metallizing, and lamination.

However, as the function of shrink film with high heat shrinkage rate is required for film application, lower heat set temperature in the range of from 80° C. to 110° C. is preferred in film making.

Table 6 showed the elongation force of the biaxially oriented PHA-rich composite film which was measured by using Instron tester at elongation rate of 3%, 6% and 9%. The elongation force was normalized to one mil thickness for comparison. The elongation force of Examples 3 and 7 was not measured due to short of film samples. The elongation force is measuring the resistance to a pulling force which is very crucial for snack food packaging and label film. A film with high elongation force which can resist high pulling force and high tension can prevent from the surface cracking of the metal or ink layers of a metallized film or printed film.

The PHA-rich composite films present elongation force higher than 10698 grams/in-mil, 11774 grams/in-mil, 12062 grams/in-mil as shown in Example 5 at a elongation rate of 3%, 6% and 9%, respectively. Example 3 demonstrates the highest elongation force probably due to its high Y1000P content and high total crystallinity in the core layer.

Table 7 showed the COFs of the PLA control film and the PHA-rich composite film samples. The “COF, A/A” is the COF of the cast side to cast side (A to A); the “COF, A/C” is the COF of cast side to air side (A to C); the “COF, C/C” is the COF of air side to air side (C to C).

Examples 2 and 3 showed COFs in the same range of the COFs of the PLA control film, indicating there are no slip additives migrating the outer surface of the film samples, however, the PHA-rich composite films showed much lower COFs, probably there exists a few amounts of additives migrating onto the outer surface of the film samples. It is noted that Examples 8 and 9 without antiblocks added into outer skin layers showed COFs comparable to that in Examples 4 to 7, suggesting that there exist slip additives pre-loaded into BP330-05 resin, and the additive can reduce the COFs of a PHA alloy film. Processing ingredients added in advance in pelletizing PHA resins can impact the COF properties of oriented PHA-rich composite film.

TABLE 3
Mechanical properties of the biaxially oriented coextruded PHA-rich composite
films made in Examples (“Ex.”), that of a BOPP film used as comparison.

| | Tensile | | Elongation at | | Young's modulus | | Tear strength | | |
|---|---|---|---|---|---|---|---|---|---|
| | strength (MPa) | | break(%) | | (MPa) | | (gram force/mil) | | |
| Example | MD | TD | MD | TD | MD | TD | MD | TD | MD/TD |
| BOPP | 115 | 234 | 176 | 30 | 1658 | 2536 | 7.5 | 6.4 | 1.2 |
| Ex. 1 | 97 | 160 | 130 | 89 | 2900 | 4236 | 14.1 | 9.3 | 1.5 |
| Ex. 2 | 70 | 129 | 95 | 58 | 3134 | 4052 | 15.8 | 11.8 | 1.3 |
| Ex. 3 | 94 | 152 | 117 | 67 | 2851 | 3920 | 9.5 | 4.0 | 2.4 |
| Ex. 4 | 73 | 125 | 150 | 94 | 2508 | 3295 | 12.8 | 9.4 | 1.4 |
| Ex. 5 | 89 | 132 | 187 | 97 | 2770 | 2188 | 10.4 | 7.7 | 1.4 |
| Ex. 6 | 96 | 172 | 173 | 86 | 2905 | 3261 | NA | NA | |
| Ex. 7 | 94 | 115 | 200 | 117 | 2592 | 2813 | 13.2 | 12.2 | 1.1 |
| Ex. 8 | 88 | 169 | 203 | 87 | 2984 | 3171 | 15.8 | 10.1 | 1.6 |
| Ex. 9 | 89 | 162 | 207 | 73 | 3003 | 3419 | 15.7 | 11.1 | 1.4 |

TABLE 4
Optical properties of the biaxially oriented coextruded PHA-
rich composite films made in Examples (“Ex.”)

| | | | |
|---|---|---|---|
| H. S. temp. | Thick. | Haze | Gloss |

| Example | ° C. | μm | % | A/60° | C/20° |
|---|---|---|---|---|---|
| Ex. 1 | 138 | 20 | 5 | 92 | 46 |
| Ex. 2 | 138 | 15 | 35 | 67 | 6 |
| Ex. 3 | 104 | 24 | 23 | 94 | 24 |
| Ex. 4 | 127 | 29 | 23 | 42 | 9 |
| Ex. 5 | 127 | 20 | 12 | 68 | 16 |
| Ex. 6 | 127 | 23 | 7 | 89 | 46 |
| Ex. 7 | 127 | 49 | 16 | 84 | 19 |
| Ex. 8 | 127 | 34 | 22 | 60 | 14 |
| Ex. 9 | 127 | 33 | 32 | 57 | 12 |

TABLE 5
Heat shrinkage of the biaxially oriented coextruded PHA-
rich composite films made in Examples (“Ex.”)

Heat shrinkage at 120° C. and
15 min. duration time

| Example | MD | TD |
|---|---|---|
| Ex. 1 | 7% | 3% |
| Ex. 2 | 4% | 7% |
| Ex. 3 | 12% | 32% |
| Ex. 4 | 3% | 6% |
| Ex. 5 | 2% | 5% |
| Ex. 6 | 1% | 7% |
| Ex. 7 | 2% | 5% |
| Ex. 8 | 0% | 8% |
| Ex. 9 | 0% | 7% |

TABLE 6
Elongation force of the biaxially oriented coextruded
PHA-rich composite films made in Examples (“Ex.”),
normalized to 1 mil thickness (25 μm).

| | Elongation force (gram/in-mil) | | |
|---|---|---|---|
| Example | 3% | 6% | 9% |
| Ex. 1 | 13248 | 14379 | 14109 |
| Ex. 3 | 16525 | 16217 | 16940 |
| Ex. 4 | 13361 | 13621 | 13798 |
| Ex. 5 | 10698 | 11774 | 12062 |
| Ex. 6 | 13052 | 13145 | 13287 |
| Ex. 8 | 12513 | 13117 | 13265 |
| Ex. 9 | 12901 | 13559 | 13684 |

TABLE 7
Coefficient of friction (COF) of the biaxially oriented PHA-
rich composite films made in Examples (“Ex.”)

| | | |
|---|---|---|
| COF, A/A | COF, A/C | COF, C/C |

| Example | μs | μd | μs | μd | μs | μd |
|---|---|---|---|---|---|---|
| Ex. 1 | 0.52 | 0.50 | 0.62 | 0.68 | 0.50 | 0.57 |
| Ex. 2 | 0.79 | 0.90 | 0.71 | 0.83 | 0.54 | 0.58 |
| Ex. 3 | 0.77 | 0.86 | 0.70 | 0.83 | 0.69 | 0.83 |
| Ex. 4 | 0.29 | 0.30 | 0.26 | 0.30 | 0.29 | 0.30 |
| Ex. 5 | 0.27 | 0.33 | 0.23 | 0.30 | 0.19 | 0.17 |
| Ex. 6 | 0.34 | 0.35 | 0.26 | 0.35 | 0.31 | 0.36 |
| Ex. 7 | 0.29 | 0.27 | 0.26 | 0.27 | 0.23 | 0.25 |
| Ex. 8 | 0.23 | 0.24 | 0.18 | 0.24 | 0.24 | 0.22 |
| Ex. 9 | 0.27 | 0.25 | 0.29 | 0.25 | 0.25 | 0.24 |

### Test Methods

The various properties in the above examples were measured by the following methods:

Differential scanning calorimetry (DSC) was used to determine the melting temperature Tm as well as glass transition temperature of the biopolymers in accordance with ASTM D3418. The heat of fusion of the biopolymers measured through DSC experiments was used to determine the crystallinity (Xc) of the biopolymers according to the heat of fusion of the perfect crystals of those biopolymers obtained from literature.

Transparency of the film was measured by measuring the haze and light transmittance of a single sheet of film using a haze meter model like a BYK Gardner “Haze-Gard Plus®” substantially in accordance with ASTM D1003.

Gloss of the film was measured by measuring the desired side of a single sheet of a film by a surface reflectivity gloss meter (BYK Gardner Micro-Gloss) substantially in accordance with ASTM D2457. The A-side or non-sealable layer side was measured at a 60° angle; the sealant layer side was measured at a 20° angle.

COF of the outer skin layers of the coextruded composite films made in Examples was measured under ambient temperature condition to determine the static and dynamic COF (μs and μd) using the method of ASTM D1894.

Mechanical properties of the coextruded composite films were tested under ambient temperature condition using the method of ASTM D882.

Tear resistance of the coextruded composite film was measured substantially accordance with ASTM D1922-09. Three samples each are cut from the plastic film samples in the machine direction (MD) and in the transverse direction (TD) for testing and data collection. The tear strength was normalized to one mil thick film.

Heat shrinkage of the coextruded composite films was measured substantially in accordance with ASTM D1204 except that the measurement condition was at three temperature levels of 80° C., 100° C. and 120° C., respectively, for a process duration time of 15 minutes.

This invention discloses several numerical ranges in the text, tables and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown in the description but is to be accorded the widest scope consistent with the principles and features disclosed herein.

### General Definitions

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As defined herein, “approximately” or “about” or similar terms can, in some embodiments, mean within plus or minus ten percent of the stated value. In other embodiments, “approximately” or “about” can mean within plus or minus five percent of the stated value. In further embodiments, “approximately” or “about” can mean within plus or minus three percent of the stated value. In yet other embodiments, “approximately” or “about” can mean within plus or minus one percent of the stated value.

The recitations of numerical ranges by endpoints include all numbers subsumed within that range (e.g., 1 to 5 includes 1, 1.5, 2, 2.75, 3, 3.80, 4, 5, etc.). Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present specification. At the very least, and not as an attempt to limit the doctrine of equivalents to the scope of the claims, each numerical parameter should at least be construed in light of the number of reported significant digits and by applying ordinary rounding techniques.

Some ranges are disclosed herein. Additional ranges may be defined between any values disclosed herein as being exemplary of a particular parameter. All such ranges are contemplated and within the scope of the present disclosure. Further, recitation of ranges of values herein is intended to serve as a shorthand method of referring individually to each separate value falling within the range. Unless otherwise indicated herein, each individual value is incorporated into the specification as if it were individually recited herein.

Notwithstanding that the numerical ranges and parameters setting forth the broad scope of the specification are approximations, the numerical values set forth in the specific examples are reported as precisely as possible. All numerical values, however, inherently contain a range necessarily resulting from the standard deviation found in their respective testing measurements.

All numbers expressing quantities of ingredients, constituents, conditions, and so forth used in the specification and claims are to be understood as being modified in all instances by the term “about”. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Unless otherwise stated, all percentages, ratios, parts, and amounts used and described herein are percentage by weight (wt %). Unless stated otherwise, molecular weight values are for weight average molecular weights.

The present invention is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

### REFERENCES

All references, including granted patents and patent application publications, referred herein are incorporated herein by reference in their entirety.

What is claimed is:

1. A biaxially oriented composite film comprising a core layer and at least one outer skin layer;
wherein the core layer is a polyhydroxyalkanoate (PHA)-rich core layer comprising a PHA resin and a non-PHA modifier X;
wherein the outer skin layer comprises a polylactic acid (PLA) resin comprising a resin having melt flow rate about 8 g/10 min. to 15 g/10 min. in an amount less than 40 wt % of a total weight of the outer skin layer and a polymeric blend Y; and
wherein the said film is home compostable as per AS 5810-2010 standard.

2. The film of claim 1, wherein the polymer blend Y comprises one or more resins having glass transition temperatures Tg≤10° C.

3. The film of claim 2, wherein one or more resins of the polymer blend Y comprises PHA, polybutylene succinate (PBS) or polybutylene succinate-co-adipate (PBSA) or polycaprolactone (PCL) or mixture thereof.

4. The film of claim 1, wherein the polymer blend Y further comprises a predetermined amount of a processing aid, a chain extender, a nucleating agent, a biodegradable promoter, a plasticizer, antiblock particles, inorganic particles and/or slip additives or mixtures thereof.

5. The film of claim 1, wherein the outer skin layer comprises TÜV-certified home compostable resins at least about 50 wt % of the total weight of the outer skin layer.

6. The film of claim 1, wherein the PLA resin is in an amount less than 50 wt % of the total weight of the outer layer.

7. The film of claim 6, wherein the PLA resin comprises a semi-crystalline PLA resin, an amorphous PLA resin, PLA copolymers or mixtures.

8. The film of claim 1, wherein the weight of the outer skin layer polymer is at an amount of about 1 to 25 wt % of the total weight of the core layer.

9. The film of claim 1, wherein the non-PHA modifier X comprises one or more resins having glass transition temperatures Tg≤60° C.

10. The film of claim 1, wherein the core layer comprises the PHA resin more than 50 wt % of a total weight of the layer.

11. The film of claim 10, wherein the PHA resin in the core layer includes a semi-crystalline PHA resin.

12. The film of claim 1, wherein the PHA resin in the core layer has a melting temperature of 145 to 180° C. and a crystallinity higher than 35%.

13. The film of claim 1, wherein the non-PHA modifier X is less than 50 wt % of a total weight of the core layer.

14. The film of claim 1, wherein the non-PHA modifier comprises a PLA resin.

15. The film of claim 1, wherein the film has a haze less than 16% as measured according to ASTM D1003.

16. The film of claim 1, wherein the film is a non-shrink film having machine direction (MD) or transverse direction (TD) heat shrinkage rate less than 10% at 120° C. at a duration time of about 15 min.

17. The film of claim 1, wherein the film has elongation force higher than 10000 grams/in-mil at 3% elongation rate.

18. The film of claim 1, wherein the film further comprises a second outer layer.

19. The film of claim 18, wherein a composition of the second outer layer is same or different than a composition of a first outer layer.
